(19) United States
(12) Patent Application Publication
(10) Pub. No.: US 2007/0173749 A1
(43) Pub. Date: Jul. 26, 2007

(54) Mechanical massage device

(75) Inventors: Christopher Edwin Williams, Swansea (GB); Elliot Lach, Framingham, MA (US)

Correspondence Address: LAHIVE & COCKFIELD, LLP, ONE POST OFFICE SQUARE, BOSTON, MA, 02109-2127, US

(73) Assignee: BioCellulase, Inc., Merrimack, NH (US)

(21) Appl. No.: 11/655,548

(22) Filed: Jan. 19, 2007

Related U.S. Application Data
(60) Provisional application No. 60/760,631, filed on Jan. 20, 2006.

(51) Int. Cl. A61H 15/00

(52) U.S. Cl. 601/123; 601/126; 601/134

(57) ABSTRACT

A massage mechanism includes a housing containing substantially uni-directional roller components. The rollers are able to rotate in one direction, but either not easily or not at all in the opposite direction. Each roller of a total of two rollers is able to rotate in a direction that is opposite of the other roller. The effect of the described configuration is that as the roller massage device moves across a skin surface of a patient, a leading edge roller is able to roll, while a trailing edge roller is held stationary, or substantially stationary. The stationary roller on the trailing edge of the roller massage device pushes against the skin, generating a skin fold. The skin fold can be further generated and magnified by the provision of a vacuum pressure within a chamber of the roller massage device, suctioning the skin up into the device, working in conjunction with the rollers. In addition, an electromagnetic force can be applied to the skin fold.

### RELATED APPLICATION

This application claims priority to, and the benefit of, co-pending U.S. Provisional Application No. 60/760,631, filed Jan. 20, 2006, for all subject matter common to both applications. The disclosure of said provisional application is hereby incorporated by reference in its entirety.

### FIELD OF THE INVENTION

The present invention relates to a device suitable for providing mechanical massage functionality, and more particularly to a massage device that combines vacuum massage with a roller mechanism forming a mechanical massage device.

### BACKGROUND OF THE INVENTION

There are a number of different mechanical massage devices that have been developed over the years to provide skin massage. There are deep tissue massage devices and massage devices that focus more on the surface of the skin and areas just below the surface. Massage devices can be manual or automated. Furthermore, massage devices can provide a variety of different massage techniques, including vibration, rolling, kneading, suction, pressure, and the like.

One approach to mechanical massage is the use of a vacuum source to suction a patient's skin and create a skin fold. In general, such devices are implemented in the form of a housing having effectively five sides and one open end forming a chamber. There is a vacuum source coupled with the interior chamber and the open end of the housing is placed on the skin of the patient. As the vacuum source is applied, skin is suctioned into the housing forming a skin fold. The housing is moved across the surface of the patient's skin. This action generates a massage effect.

In order to enable the housing to move across the skin of the patient, there are two primary mechanisms that are utilized. One mechanism option is to create a relatively slippery surface on the portion of the housing contacting the skin, enabling the housing to slide across the skin. A second mechanism option is to place a number of rollers in the housing that lift the housing off of the skin, such that the rollers become the primary contact point for the skin rather than the housing. As the housing moves across the skin the rollers roll.

U.S. Pat. No. 5,885,232 is one example of such a device having rollers within a vacuum housing. In general, the massage apparatus according to the '232 patent performs massage treatments utilizing the actions of suction and mobilization of the skin tissue. The device includes two parallel rollers mounted inside a casing so that they are free to rotate in the casing. The casing is connected to means comprising a conduit whose end opens into the space contained between the rollers, making it possible to create a reduced pressure in the casing, in the space contained between these rollers, when the latter are applied against the patient's body. The rollers in the '232 patent are not driven by any motors. However, the '232 patent refers to another solution described in French Patent No. FR-A-2 579 100, wherein one of the rollers is positively driven in rotation and the second is combined with means making it possible to move it away from the drive roller.

None of the above devices uses the roller components to positively contribute to the formation of the skin fold working in conjunction with the vacuum source, as provided in accordance with the present invention.

### SUMMARY

There is a need for a roller massage device having substantially uni-directional roller components. The rollers are able to rotate in one direction, but are either substantially hindered, or do not rotate at all, in the opposite direction. Each roller of a total of two rollers is able to rotate in a direction that is opposite of the other roller. The effect of the described configuration is that as the roller massage device moves across a skin surface of a patient, a leading edge roller is able to roll, while a trailing edge roller is held stationary. The stationary roller on the trailing edge of the roller massage device pushes against the skin, generating a skin fold. The present invention is directed toward further solutions to address this need, in addition to having other desirable characteristics.

In accordance with one embodiment of the present invention, a massage device includes a housing having a pair of opposed side walls and top wall forming an open chamber. A first roller can be rotatably mounted between the pair of opposed side walls and able to rotate about a first axis. A second roller can be rotatably mounted between the pair of opposed side walls and able to rotate about a second axis. A first rotational control mechanism can be coupled with the first roller. A second rotational control mechanism can be coupled with the second roller. The first rotational control mechanism can be configured to permit the first roller to rotate in a first rotational direction about the first axis and at least substantially hinder, or prevent, rotation in a second rotational direction about the first axis opposite the first rotational direction. The second rotational control mechanism can be configured to permit the second roller to rotate in the second rotational direction about the second axis and at least substantially hinder, or prevent, rotation in the first rotational direction about the second axis.

In accordance with various aspects of the present invention, the massage device is operable to travel across a surface in a first linear direction and a second linear direction substantially opposite the first linear direction. The first and second rollers can be arranged such that if the massage device travels across the surface in the first linear direction, the first roller rotates in the first rotational direction and the second rotational control mechanism at least substantially hinders rotation of the second roller in the first rotational direction. The first and second rollers can be arranged such that if the massage device travels across the surface in the second linear direction, the first rotational control mechanism at least substantially hinders rotation of the first roller in the second rotational direction and the second roller rotates in the second rotational direction.

In accordance with variations in the embodiments of the present invention, the massage device further includes at least one pair of slots supporting the first roller, the second roller, or both. At least one spring bias can be applied to the first roller, the second roller, or both, biasing the roller toward an outer edge of the device away from the other roller. At least one electromagnetic energy emitter providing electromagnetic energy generally within the housing can be provided such that the electromagnetic energy can be applied to a skin fold generated by the massage device. The first roller and/or the second roller can have a knurled surface across at least a portion thereon. The first roller and/or the second roller can have at least one insert embedded therein. The at least one insert can be an insert of different material from that which forms a surface of the first roller and/or the second roller. The at least one insert can be a metal insert embedded within a substantially non-metal roller surface. The at least one insert can be a plurality of inserts embedded in the first roller and/or the second roller such that a surface of the plurality of inserts substantially follows a contour of the first roller and/or the second roller surfaces. The first rotational control mechanism, the second rotational control mechanism, or both, can be in the form of a ratchet mechanism. A port can be provided, configured to receive a vacuum pressure source and convey vacuum pressure to the open chamber.

In accordance with aspects of the present invention, a method of making a massage device includes forming a housing having a pair of opposed side walls and top wall forming an open chamber, rotatably mounting a first roller between the pair of opposed side walls that is able to rotate about a first axis, rotatably mounting a second roller between the pair of opposed side walls that is able to rotate about a second axis, providing a first rotational control mechanism coupled with the first roller, and providing a second rotational control mechanism coupled with the second roller. The first rotational control mechanism can be configured to permit the first roller to rotate in a first rotational direction about the first axis and at least substantially hinder, or prevent, rotation in a second rotational direction about the first axis opposite the first rotational direction. Likewise, the second rotational control mechanism can be configured to permit the second roller to rotate in the second rotational direction about the second axis and at least substantially hinder, or prevent, rotation in the first rotational direction about the second axis.

In accordance with variations of the present invention, the massage device can be operable to travel across a surface in a first linear direction and a second linear direction substantially opposite the first linear direction. The first and second rollers can be arranged such that if the massage device travels across the surface in the first linear direction, the first roller rotates in the first rotational direction and the second rotational control mechanism at least substantially hinders rotation of the second roller in the first rotational direction. The first and second rollers can be arranged such that if the massage device travels across the surface in the second linear direction, the first rotational control mechanism at least substantially hinders rotation of the first roller in the second rotational direction and the second roller rotates in the second rotational direction.

In accordance with aspects of the present invention, a method of using a massage mechanism includes obtaining the massage mechanism, where the massage mechanism includes a housing having a pair of opposed side walls and top wall forming an open chamber, a first roller rotatably mounted between the pair of opposed side walls and able to rotate about a first axis, a second roller rotatably mounted between the pair of opposed side walls and able to rotate about a second axis, a first rotational control mechanism coupled with the first roller, and a second rotational control mechanism coupled with the second roller. The first rotational control mechanism can be configured to permit the first roller to rotate in a first rotational direction about the first axis and at least substantially hinder, or prevent, rotation in a second rotational direction about the first axis opposite the first rotational direction. Likewise, the second rotational control mechanism can be configured to permit the second roller to rotate in the second rotational direction about the second axis and at least substantially hinders, or prevents, rotation in the first rotational direction about the second axis. The method further includes positioning the first and second rollers of the massage mechanism on a tissue surface to be massaged, and motivating the massage mechanism in a first direction, causing a skin fold to form ahead of the second roller to massage the tissue.

In accordance with variations of the present invention, the method can further include motivating the massage mechanism in a second direction opposite the first direction, causing a skin fold to form ahead of the first roller. Likewise, the method can further include alternating motivation of the massage mechanism between movement in the first direction and movement in the second direction.

### BRIEF DESCRIPTION OF THE DRAWINGS

The present invention will become better understood with reference to the following description and accompanying drawings, wherein:

FIG. 1 is a perspective cutaway illustration of a roller massage device, in accordance with one embodiment of the present invention;

FIG. 2 is a bottom view of the roller massage device, according to one aspect of the present invention;

FIG. 3 is a perspective close-up cutaway view of a ratchet portion of a roller component of the roller massage device, according to one aspect of the present invention;

FIG. 4A is an exploded view of the ratchet mechanism in the roller component of the roller massage device, according to one aspect of the present invention;

FIG. 4B is a perspective view of the ratchet mechanism in the roller component of the roller massage device, according to one aspect of the present invention;

FIG. 5 is a side view showing creation of a skin fold by the roller massage device, according to one aspect of the present invention;

FIG. 6 is a side view of the roller massage device, according to one aspect of the present invention;

FIG. 7 is a perspective view of the rollers with a knurled surface, according to one aspect of the present invention; and

FIGS. 8A, 8B, 8C, and 8D are perspective views of the rollers with various insert configurations embedded therein.

### DETAILED DESCRIPTION

An illustrative embodiment of the present invention relates to a roller massage device having substantially unidirectional roller components. The rollers are able to rotate in one direction, but either not easily or not at all in the opposite direction, and each roller of a total of two rollers is able to rotate in a direction that is opposite of the other roller. The effect of the described configuration is that as the roller massage device moves across a skin surface of a patient, a leading edge roller is able to roll, while a trailing edge roller is held stationary. The stationary roller on the trailing edge of the roller massage device pushes against the skin, generating a skin fold. The skin fold is further generated and magnified by the provision of a vacuum pressure within a chamber of the roller massage device, suctioning the skin up into the device. The roller components thus work in conjunction with the vacuum pressure to create a skin fold and magnify the amount of the skin fold to create a more effective massage mechanism.

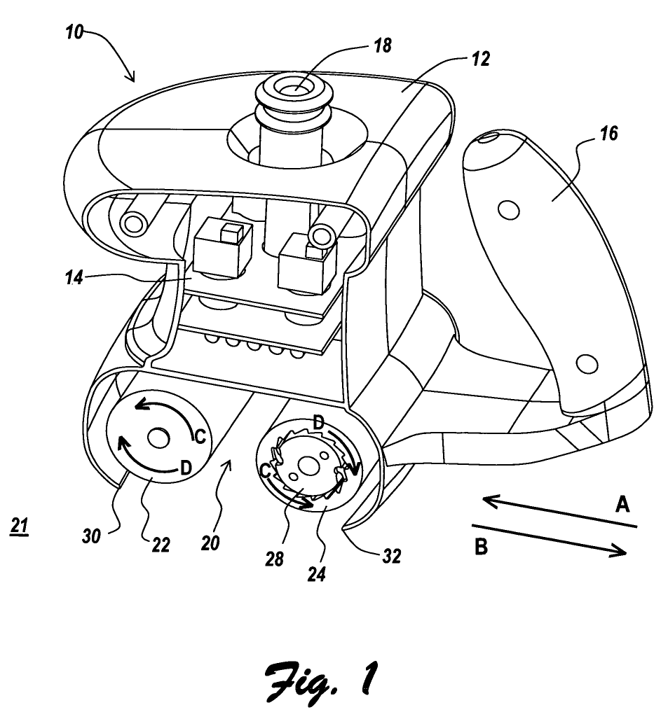

FIGS. 1 through 8D, wherein like parts are designated by like reference numerals throughout, illustrate an example embodiment of a roller massage device according to the present invention. Although the present invention will be described with reference to the example embodiment illustrated in the figures, it should be understood that many alternative forms can embody the present invention. One of ordinary skill in the art will additionally appreciate different ways to alter the parameters of the embodiment disclosed, such as the size, shape, or type of elements or materials, in a manner still in keeping with the spirit and scope of the present invention.

FIG. 1 is a perspective cutaway illustration of a roller massage device 10 in accordance with the present invention. The roller massage device 10 has a housing 12 constructed of any number of suitable materials, including plastics, composites, metals, synthetics, naturally occurring materials, and the like. The housing 12 can also maintain a number of different shapes as would be understood by one of ordinary skill in the art. The illustrative housing 12 includes a component compartment 14, which holds a number of different components that may be included in the design of the device. For example, the components can include electronics related to massage performance, controller related components, laser or LED or other electromagnetic emitting components or controllers, timing devices, power components, and any other similar component or mechanism that would be useful for implementing the massage mechanism or for use in conjunction with the massage mechanism. The housing 12 further includes a handle 16 for a user to grip and move the roller massage device 10 during use.

The roller massage device 10 further includes a vacuum conduit 18. The vacuum conduit 18 extends from an outer edge of the housing 12 through to an inner chamber 20. The vacuum conduit 18 is sized and dimensioned to couple with a vacuum source (not shown) to provide negative pressure to the inner chamber 20 under conditions described herein. It should be noted that the terms vacuum, suction, and negative pressure are all interchangeable as utilized herein and relate to a measurement of the air pressure in the chamber and the vacuum conduit 18 relative to an atmospheric or environmental pressure external to the roller massage device 10.

The vacuum conduit 18 places the chamber 20 into a condition of negative pressure when the chamber 20 is placed up against a skin surface 21 of a patient and the vacuum conduit 18 connects with a vacuum source. Snug placement of the roller massage device 10 against the skin surface 21 closes off the remaining open side of the chamber 20, which is otherwise formed by the housing 12, a first roller 22, a second roller 24, a first edge 30, and a second edge 32. It should be noted that the figure is a cutaway illustration, thus the housing 12 extends along the side covering the component compartment 14 and the rollers 22, 24.

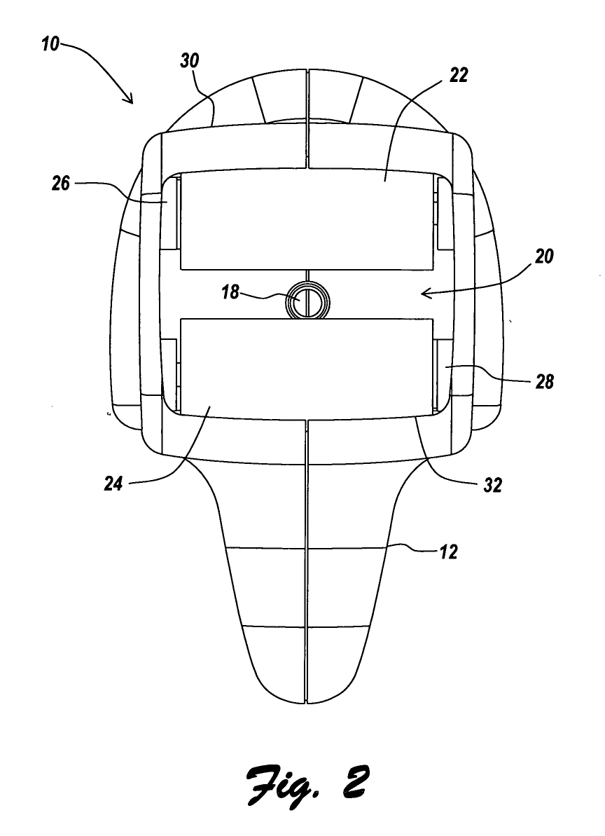

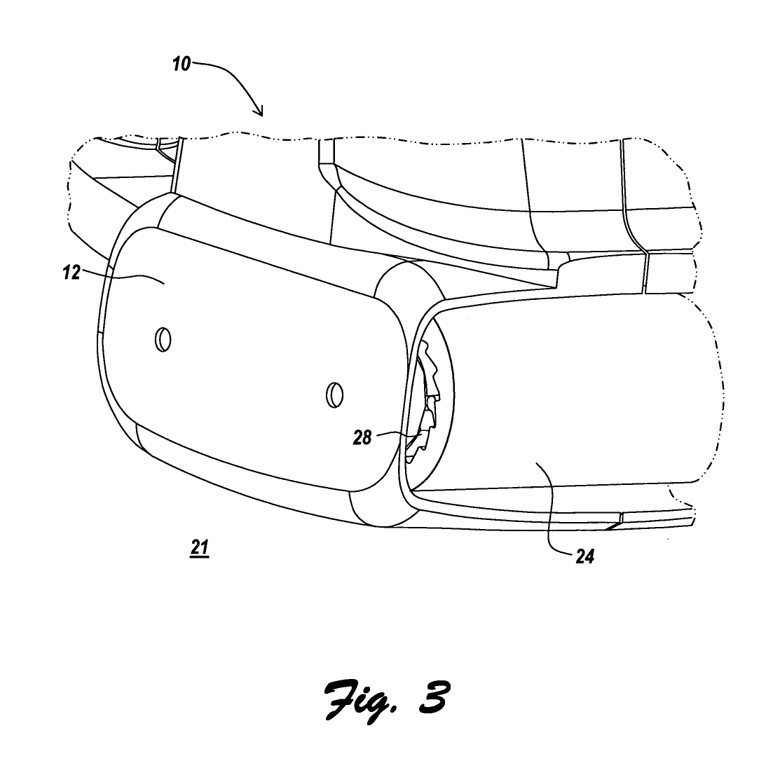

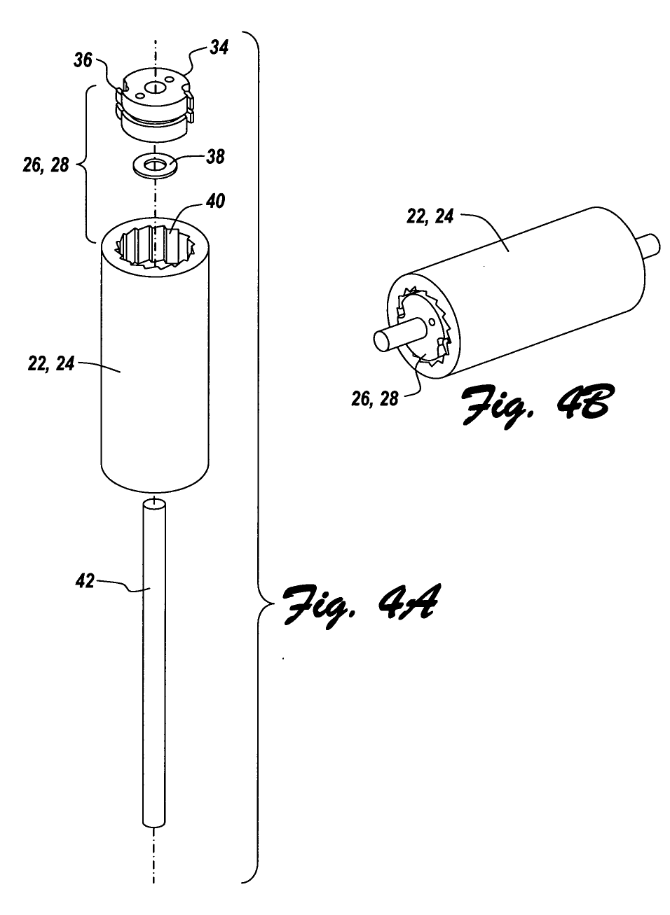

The first roller 22 and the second roller 24 each rotate about an axis (such as axle 42 in FIG. 4A) within the chamber 20. The first roller 22 is coupled with a rotational control mechanism in the form of a first ratchet 26 and the second roller 24 is coupled with another rotational control mechanism in the form of a second ratchet 28 (see FIG. 2), each in accordance with one embodiment of the present invention. The first and second ratchets 26 and 28 serve to allow rotation of their respective rollers 22, 24 to which they are coupled in one direction as will be later described herein. The first and second rollers 22 and 24 can be formed of a number of different materials, including plastics, composites, metal, synthetics, naturally occurring materials, and the like. Likewise, the rotational control mechanisms can be ratchets, as illustrated herein, or can be other rotational control mechanisms as would be understood by one of ordinary skill in the art. For example, the rotational control mechanisms can include mechanisms that allow rotation only in one direction, and not in an opposite direction, or the rotational control mechanisms can allow rotation in one direction and substantially hinder rotation in the opposite direction. One of ordinary skill in the art will appreciate that there are a number of conventional mechanical solutions for controlling rotation about an axis, all of which are considered to fall within the scope of the rotational control mechanisms of the present invention, and include but are not limited to clutches, ratchet mechanisms, brakes, gearing combinations, friction application mechanisms, spring biased devices, and the like. As such, although the present description illustrates the rotational control mechanisms in the form of ratchet devices, the present invention is not limited to only ratchet devices, but can be implemented using other rotational control mechanisms.

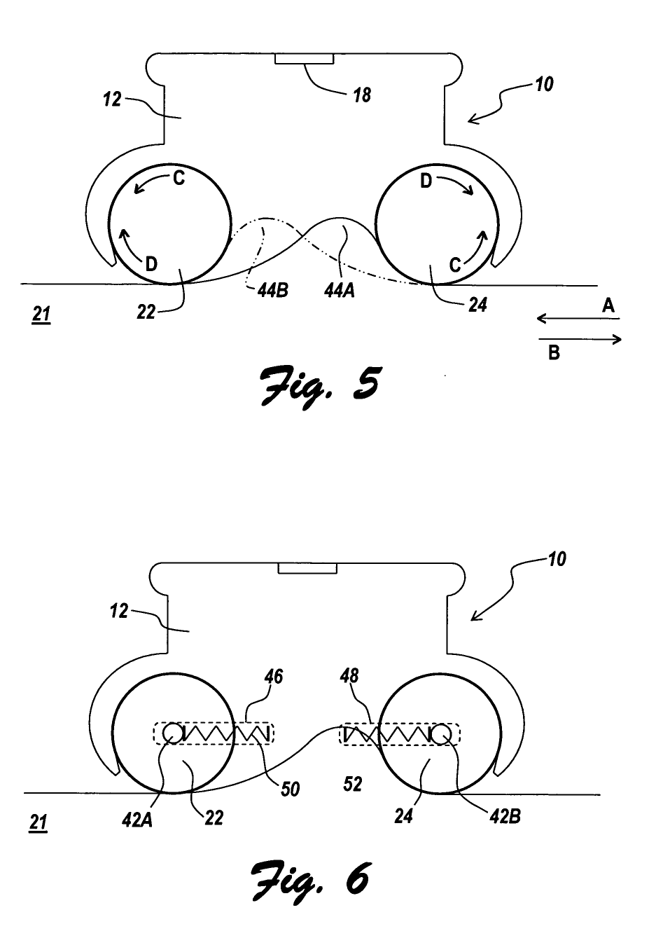

The first and second rollers 22 and 24 are rotatably mounted, as described, and can additionally be slidably mounted within the housing 12. For example, two pairs of slots 46, 48 (see FIG. 6) can be provided in the side walls of the housing 12 such that the axles 42 of the first and second rollers 22 and 24 can slide along the interior walls of the chamber 20. This provides the first and second rollers 22 and 24 with the ability move toward each other and away from each other during operation. The first and second rollers 22 and 24 can further be provided with spring biasing means 50, 52 (see FIG. 6) along the two pairs of slots 46, 48 to bias the rollers away from each other. This spring biasing means 50, 52 can act counter to the suction force that is created when the vacuum source is applied to the chamber 20 and a skin fold 44 (see skin fold 44a and 44b in FIG. 5) (“skin fold 44” as utilized herein refers to one or both of skin fold 44a and skin fold 44b in the figures) is brought up into the chamber 20 as later described.

It should be noted that the two pairs of slots 46, 48 in FIG. 6 refers to a first pair of slots 46 supporting the first roller 22 and a second pair of slots 48 supporting the second roller 24. As illustrated, only one slot from each pair of slots 46, 48 is shown. The other slot from each pair of slots 46, 48 is disposed on the opposite side of the housing 12, supporting the other end of each roller 22, 24 as would be understood by one of ordinary skill in the art.

During application of the vacuum source, the negative pressure would otherwise cause the first and second rollers 22 and 24 to move toward each other narrowing the gap therebetween, thus allowing for a lesser volume of skin fold 44 to be brought up into the chamber 20. However, the spring biasing means 50, 52 can act opposite to the suction force of the vacuum source and bias the first and second rollers 22 and 24 apart prior to contacting the skin surface 21. Once a seal is made with the skin surface, the suction of the vacuum source can overpower the spring biasing means 50, 52 and move the first and second rollers 22 and 24 together. It should be noted that it is possible for only one of the two spring biasing means 50, 52 illustrated to be provided, thus acting on only one of the two rollers 22, 24.

FIG. 2 shows a bottom view of the roller massage device 10 in accordance with the illustrative embodiment of the present invention. The vacuum conduit 18 is shown entering the chamber 20 in a generally centralized location. However, one of ordinary skill in the art will appreciate that the vacuum conduit 18 can enter the chamber 20 area in any location along the chamber 20 walls. Accordingly, the present invention is not limited to the specific configuration of the illustrative embodiment.

In addition, the placement of the first ratchet 26 at the end of the first roller 22 and the placement of the second ratchet 28 at the end of the second roller 24 is shown. The placement of the first ratchet 26 at an opposite side of the housing 12 from the second ratchet 28 is a configuration that enables the use of ratchet mechanisms having the same configuration, allowing rotation in the same rotational direction and hindering rotation in the same opposite rotational direction. The placement of the first and second ratchets 26 and 28 on opposite sides of the housing 12 results in the first and second rollers 22 and 24 being able to freely rotate in opposite rotational directions from each other. One of ordinary skill in the art will appreciate that if the first and second ratchets 26 and 28 are of opposite rotational orientations (i.e., allowing rotation in opposite rotational directions from each other), then the first and second ratchets 26 and 28 would be placed on the first and second rollers 22 and 24 on the same side of the housing 12 to result in the first and second rollers 22 and 24 being able to rotate freely in opposite rotational directions. Thus, the present invention is again not limited to the specific configuration illustrated. Rather, the present invention intends a ratchet and roller combination that results in the first and second rollers 22 and 24 being able to rotate freely in opposite rotational directions, and be at least substantially hindered from rotation in opposite rotational directions, as shown.

The illustration of FIG. 2 further shows the arrangement of the first roller 22 relative to the first edge 30 and the second roller 24 relative to the second edge 32. Specifically, a very small clearance is provided between the first roller 22 and the first 30. Likewise, a very small clearance is provided between the second roller 24 and the second edge 32. The clearance in both instances is merely sufficient to allow rotation of the first and second rollers 22 and 24 without hindrance from frictional contact with the first and second edges 30 and 32. The clearance thus provides a very small gap where air can enter the chamber 20 when the chamber is in a negative pressure condition. However, the clearance is sufficiently small so as not to prevent the negative pressure condition from existing upon application of the vacuum source through the vacuum conduit 18.

FIG. 3 is a cutaway perspective view providing a close up of the second ratchet 28 coupled with the second roller 24 as it is mounted within the housing 12. The cutaway view has removed the back portion of the housing 12 that is shown in FIG. 1, but replaces the side walls of the housing 12 that are absent from the cutaway view of FIG. 1. Illustrated in the present figure is the relationship between the roller 24 and the housing 12, providing very small clearances on all sides of the roller 24.

FIG. 4A is an exploded view of an illustrative embodiment of the ratchet 26, 28 coupled with the roller 22, 24. In accordance with one example embodiment of the present invention, the ratchet 26, 28 is formed of a pawl wheel 34 having a plurality of pawls 36 pivotably extending therefrom. The pawl wheel 34 fits within an end of the roller 22, 24 having a series of ratchet teeth 40, with a washer 38 therebetween. The axle 42 (see also axles 42a and 42b in FIG. 6) (“axle 42” as utilized herein refers to one or both of axle 42a and axle 42b in the figures) then slides through and supports the roller 22, 24, the washer 38, and the pawl wheel 34 of the ratchet 26, 28. The assembled ratchet 26, 28 coupled with the roller 22, 24 is shown in FIG. 4B. As the roller 22, 24 rolls in one rotational direction, the plurality of pawls 36 slide over the ratchet teeth 40. Once the roller begins rotation in an opposite rotational direction, the plurality of pawls 36 dig in between the ratchet teeth 40 and prevent rotation of the roller 22, 24. If a clutch mechanism is provided in the pawl wheel 34, the rotation of the roller 22, 24 will be substantially hindered rather than altogether halted by the engagement of the plurality of pawls 36 with the ratchet teeth 40, as would be understood by one of ordinary skill in the art.

In operation, and referring back to FIG. 1 and also FIG. 5, the roller massage device 10 functions as follows. Relative to the arrows shown in the figures, if the roller massage device 10 is first moved in the direction of arrow A, then the first roller 22 becomes the leading edge roller and is permitted by the first ratchet 26 to rotate in the rotational direction of arrows C. Contemporaneously, the second roller 24 becomes the trailing or following edge roller and the second ratchet 28 at least substantially hinders, if not altogether halts, rotation in the rotational direction of arrows C. If the roller massage device 10 is being operated across a skin surface 21 of a patient, then the lack or hindrance of rotational motion on the part of the trailing or following edge roller (the second roller 24) due to the rotational control mechanism causes the skin fold 44a to bunch up along the front of the second roller 24. This result works in conjunction with a simultaneously applied negative pressure within the chamber 20 from the vacuum source through the vacuum conduit 18, which further pulls up the skin surface 21 magnifying the size of the skin fold 44a created.

In the event the roller massage device 10 reverses direction and begins traveling in the general direction of arrow B, then the following occurs. The second roller 24 becomes the leading edge roller and is permitted by the second ratchet 28 to rotate in the rotational direction of arrows D. Contemporaneously, the first roller 22 becomes the trailing or following edge roller and the first ratchet 26 at least substantially hinders, if not altogether halts, rotation in the rotational direction of arrows D. If the roller massage device 10 is being operated across a skin surface 21 of a patient, then the lack of rotational motion on the part of the trailing or following edge roller (the first roller 22), or hindrance in the case of clutch or other device usage, causes the skin fold 44b to bunch up along the front of the first roller 22. This result again works in conjunction with a simultaneously applied negative pressure within the chamber 20 from the vacuum source through the vacuum conduit 18, which further pulls up the skin surface 21 magnifying the size of the skin fold 44b created.

In addition to the operation of the roller massage device 10 from the vacuum massage perspective, the roller massage device 10 can further provide treatment to the skin fold 44 using the components within the component compartment 14. For example, if one or more lasers or LEDs, RF generators, magnets or the like are provided in the component compartment 14, then the substantial skin fold 44 that is created by the roller massage device 10 of the present invention can be better exposed to infrared or other electromagnetic energy emitted from the general area of the component compartment 14. Such additional treatments that are available are understood by those of ordinary skill in art, and will therefore not be further described herein other than to indicate that all such treatments can be performed on the skin fold 44 from the component compartment 14.

The surface and materials forming the first roller 22 and the second roller 24 can have a number of different variations. For example, the surface of the rollers 22, 24 can be smooth, or can have a texture, or be knurled, such as a knurled surface 60 shown in FIG. 7. The knurled surface 60 can be formed in a number of different patterns, including a set of parallel lines similar to the edge of a coin, or a crisscross pattern, similar to a metal file.

Regardless of pattern, the textured or knurled surface 60 is formed of a series of 3-dimensional protuberances or projections (or corresponding notches or valleys), the precise dimensions and layout of which can be varied depending on the desired functionality of the knurled surface 60 with regard to the use of the massage device 10. For example, the textured or knurled surface can facilitate superficial massage of the skin in order to effect a smoother skin surface. The knurled surface 60 can also break up superficial dry skin and skin keratoses, thus creating a softer skin surface. Such functionality can equate to a method of exfoliation in that it can break up the bonds that hold dead dry skin to reveal softer underlying skin.

The knurled surface 60 having a smaller grain is more appropriate for the exfoliation functionality, wherein the knurled surface 60 having a relatively larger grain is more appropriate for enabling deep tissue massage functionality. The range of dimensions can be generally that which would allow between about 2 to about 50 protuberances within a one square inch area, and preferably between about 4 and about 30 protuberances or units forming the knurled pattern. In addition, the total area covered by the knurled surface 60 can likewise vary to include portions of the roller, or can cover the entire roller surface.

The combination of vacuum and the knurled surface has application in a plurality of locations throughout the body, including but not limited to the face, palms, leg, soles of the feet, legs, and anywhere else where dry skin may be a clinical problem. One of ordinary skill in the art will appreciate that in the instances comprising a knurled surface, the relative size of the protuberances forming the knurled surface 60 and the spaces between the protuberances can affect the operation of the vacuum on the skin. The knurled surface 60 must pass by the outer edge of the housing 12, between the roller 22, 24 and the housing 12. Thus, the larger the spaces and protuberances, i.e., the larger the granularity of the knurled surface 60, the easier it is for air to flow through and reduce the effectiveness of the vacuum. Accordingly, larger protuberances for deeper tissue massage will correspond with a lesser vacuum action on the skin fold, while smaller protuberances with smaller spaces between (i.e., a finer granularity knurled surface 60) will correspond with a greater vacuum action on the skin fold.

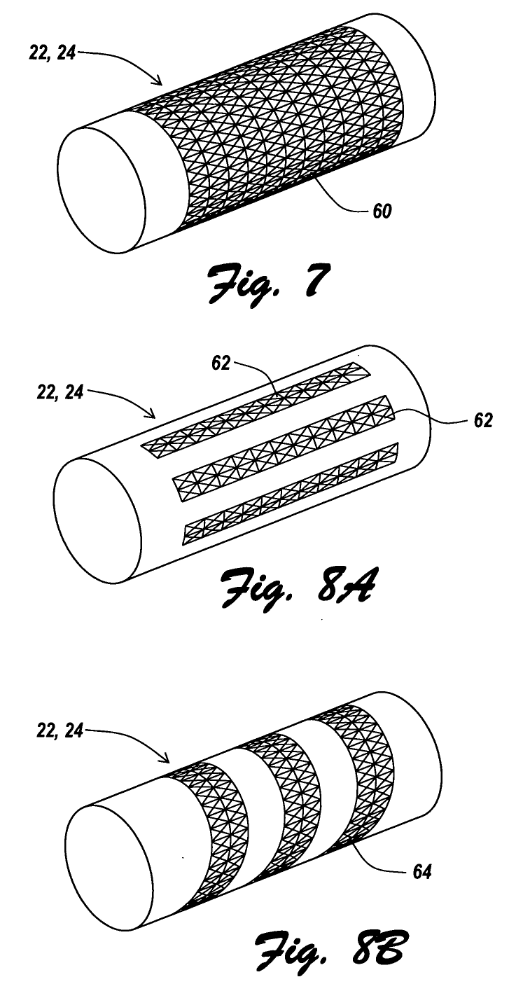

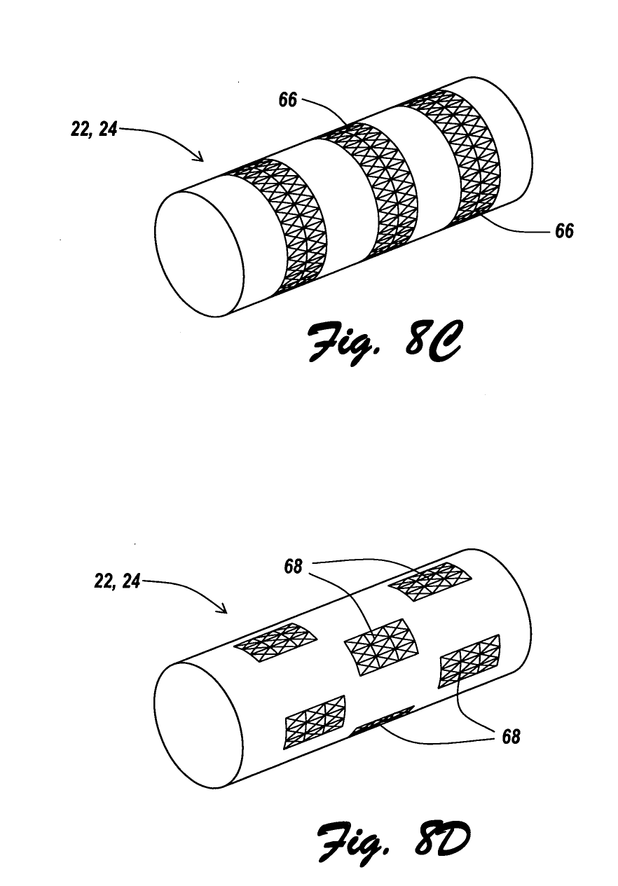

As previously mentioned, the first and second rollers 22 and 24 can be formed of a number of different materials, including plastics, composites, metal, synthetics, naturally occurring materials, and the like. In addition, the first and second rollers 22 and 24 can be formed of a combination of such materials. For example, and looking at FIGS. 8A, 8B, 8C, and 8D, parallel inserts 62 are embedded within the first and second rollers 22 and 24 (see FIG. 8A). Alternatively, the embedded materials can be spiral 64 (see FIG. 8B), ring-like 66 (see FIG. 8C), or scattered inserts 68 (see FIG. 8D). In addition, there can be a number of different materials beyond one or two, utilized to form the surface of the first and second rollers 22 and 24, as would be understood by one of ordinary skill in the art. Specifically, the parallel inserts 62, spiral 64, ring-like 66, and scattered places 68, i.e., the embedded structures, can be made of metal, while the rollers 22, 24 are made of plastic or composite. Alternatively, the embedded structures can be made of plastic, while the rollers 22, 24 are formed of metal. Any combination of materials for the rollers 22, 24 and the embedded structures can be implemented.

Whether at room temperature or at a refrigerated temperature, metal, when touching the skin feels cold due to its heat conductive nature. The process of skin massage results in friction and heat generation, which may limit the treatments due to pain. The process is also aimed at mobilizing trapped fluid. A subjective feeling of cold can enable application of a more aggressive massage treatment because of the reduced pain perceived by the patient during treatment. In addition, the cool surface of the roller when touching the skin facilitates lymphatic circulation by creating a temperature differential at the skin/roller interface. This promotes a pumping action that allows trapped fluid to clear the skin and thereby reduce the appearance of bumps and cellulite.

Accordingly, the present invention provides an improved roller massage device 10 that combines mechanical action of rollers configured to hinder or halt rotation in a configuration or arrangement that creates a skin fold 44, which is further enhanced by the provision of a vacuum source to the chamber 20 in which the skin fold 44 is created. One of ordinary skill in the art will appreciate that while the mechanical action of the rollers and ratchets to create the skin fold 44 can work in conjunction with the vacuum source, the present invention is not so limited. Rather, the present invention includes the operation of the roller massage device without the vacuum source providing the negative pressure in the chamber as well, if desired.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the invention, and exclusive use of all modifications that come within the scope of the appended claims is reserved.

What is claimed is:

1. A massage device, comprising:
a housing having a pair of opposed side walls and top wall forming an open chamber;
a first roller rotatably mounted between the pair of opposed side walls and able to rotate about a first axis;
a second roller rotatably mounted between the pair of opposed side walls and able to rotate about a second axis;
a first rotational control mechanism coupled with the first roller;
a second rotational control mechanism coupled with the second roller;
wherein the first rotational control mechanism is configured to permit the first roller to rotate in a first rotational direction about the first axis and at least substantially hinders, or prevents, rotation in a second rotational direction about the first axis opposite the first rotational direction; and
wherein the second rotational control mechanism is configured to permit the second roller to rotate in the second rotational direction about the second axis and at least substantially hinders, or prevents, rotation in the first rotational direction about the second axis.

2. The device of claim 1, wherein the massage device is operable to travel across a surface in a first linear direction and a second linear direction substantially opposite the first linear direction.

3. The device of claim 2, wherein the first and second rollers are arranged such that if the massage device travels across the surface in the first linear direction, the first roller rotates in the first rotational direction and the second rotational control mechanism at least substantially hinders rotation of the second roller in the first rotational direction.

4. The device of claim 2, wherein the first and second rollers are arranged such that if the massage device travels across the surface in the second linear direction, the first rotational control mechanism at least substantially hinders rotation of the first roller in the second rotational direction and the second roller rotates in the second rotational direction.

5. The device of claim 1, further comprising at least one pair of slots supporting the first roller, the second roller, or both.

6. The device of claim 5, further comprising at least one spring bias applied to the first roller, the second roller, or both, biasing the roller toward an outer edge of the device away from the other roller.

7. The device of claim 1, further comprising at least one electromagnetic energy emitter providing electromagnetic energy generally within the housing such that the electromagnetic energy can be applied to a skin fold generated by the massage device.

8. The device of claim 1, further comprising the first roller, the second roller, or both, having a knurled surface across at least a portion thereon.

9. The device of claim 1, further comprising the first roller, the second roller, or both, having at least one insert embedded therein.

10. The device of claim 9, wherein the at least one insert comprises an insert of different material from that which forms a surface of the first roller, the second roller, or both.

11. The device of claim 9, wherein the at least one insert comprises a metal insert embedded within a substantially non-metal roller surface.

12. The device of claim 9, wherein the at least one insert comprises a plurality of inserts embedded in the first roller, the second roller, or both, such that a surface of the plurality of inserts substantially follows a contour of the surfaces of the first roller, the second roller, or both.

13. The device of claim 1, wherein the first rotational control mechanism, the second rotational control mechanism, or both, comprise a ratchet mechanism.

14. The device of claim 1, further comprising a port configured to receive a vacuum pressure source and convey vacuum pressure to the open chamber.

15. A method of making a massage device, comprising:
forming a housing having a pair of opposed side walls and top wall forming an open chamber;
rotatably mounting a first roller between the pair of opposed side walls that is able to rotate about a first axis;
rotatably mounting a second roller between the pair of opposed side walls that is able to rotate about a second axis;
providing a first rotational control mechanism coupled with the first roller;
providing a second rotational control mechanism coupled with the second roller;
wherein the first rotational control mechanism is configured to permit the first roller to rotate in a first rotational direction about the first axis and at least substantially hinders, or prevents, rotation in a second rotational direction about the first axis opposite the first rotational direction; and
wherein the second rotational control mechanism is configured to permit the second roller to rotate in the second rotational direction about the second axis and at least substantially hinders, or prevents, rotation in the first rotational direction about the second axis.

16. The method of claim 15, wherein the massage device is operable to travel across a surface in a first linear direction and a second linear direction substantially opposite the first linear direction.

17. The method of claim 16, wherein the first and second rollers are arranged such that if the massage device travels across the surface in the first linear direction, the first roller rotates in the first rotational direction and the second rotational control mechanism at least substantially hinders rotation of the second roller in the first rotational direction.

18. The method of claim 16, wherein the first and second rollers are arranged such that if the massage device travels across the surface in the second linear direction, the first rotational control mechanism at least substantially hinders rotation of the first roller in the second rotational direction and the second roller rotates in the second rotational direction.

19. The method of claim 15, further comprising providing at least one pair of slots supporting the first roller, the second roller, or both.

20. The method of claim 19, further comprising providing at least one spring bias applied to the first roller, the second roller, or both, biasing the roller toward an outer edge of the device away from the other roller.

21. The method of claim 15, further comprising providing at least one electromagnetic energy emitter providing electromagnetic energy generally within the housing such that the electromagnetic energy can be applied to a skin fold generated by the massage device.

22. The method of claim 15, further comprising providing a port configured to receive a vacuum pressure source and convey vacuum pressure to the open chamber.

23. A method of using a massage mechanism, comprising:
obtaining the massage mechanism comprising:
a housing having a pair of opposed side walls and top wall forming an open chamber;
a first roller rotatably mounted between the pair of opposed side walls and able to rotate about a first axis;
a second roller rotatably mounted between the pair of opposed side walls and able to rotate about a second axis;
a first rotational control mechanism coupled with the first roller;
a second rotational control mechanism coupled with the second roller;
wherein the first rotational control mechanism is configured to permit the first roller to rotate in a first rotational direction about the first axis and at least substantially hinders, or prevents, rotation in a second rotational direction about the first axis opposite the first rotational direction; and
wherein the second rotational control mechanism is configured to permit the second roller to rotate in the second rotational direction about the second axis and at least substantially hinders, or prevents, rotation in the first rotational direction about the second axis;
positioning the first and second rollers of the massage mechanism on a tissue surface to be massaged; and
motivating the massage mechanism in a first direction, causing a skin fold to form ahead of the second roller to massage the tissue.

24. The method of claim 23, further comprising motivating the massage mechanism in a second direction opposite the first direction, causing a skin fold to form ahead of the first roller.

25. The method of claim 24, further comprising alternating motivation of the massage mechanism between movement in the first direction and movement in the second direction.

26. The method of claim 23, further comprising providing a vacuum source to the massage mechanism that magnifies the skin fold formation.

27. The method of claim 23, further comprising providing an electromagnetic force to the skin fold.
